(19) United States
(12) Patent Application Publication
(10) Pub. No.: US 2005/0235501 A1
(43) Pub. Date: Oct. 27, 2005

(54) Handheld electric-powered can opener

(76) Inventor: Shun So, Kowloon (HK)

Correspondence Address: LEYDIG VOIT & MAYER, LTD, 700 THIRTEENTH ST. NW, SUITE 300, WASHINGTON, DC, 20005-3960, US

(21) Appl. No.: 10/830,441

(22) Filed: Apr. 23, 2004

(51) Int. Cl. B67B 7/46

(52) U.S. Cl. 30/425

(57) ABSTRACT

A handheld electric-powered can opener has a body with a handle and a head. A battery and motor are provided within the handle. A gearbox is coupled to the motor and a rotational traction wheel positioned on the head. A rotational cutting wheel is positioned on the head and coupled to a lever for forcing the cutting wheel against a can rim. A switch is provided to operate the motor when the lever is forcing the cutting wheel against a can rim.

### BACKGROUND OF THE INVENTION

1. Field of the Invention

The invention relates to can openers, and in particular to handheld can openers and to electric-powered can openers. The invention also relates to can openers of the lateral rim cutting type that have a rotational circular traction wheel and a rotational circular cutter blade for engagement with a metal can for removing an end therefrom.

2. Background Information

Many handheld can openers are known. An example of a handheld can opener is in applicant's U.S. Pat. No. 6,058,613 issued on 9 May 2000. This can opener is of the lateral rim cutting type in which a rotational circular cutter blade penetrates a radially outer thickness of metal material comprising a can rim but does not cut completely through the rim whereby the can end may be cut leaving a smooth edge both to the end and the side wall of the can.

A disadvantage of this can opener, and others like it, is that the user must turn a handle/crank to operate it. This can be difficult for people with disabilities affecting the hands or people with weak hands generally such as the elderly.

Electric-powered can openers are known. Most electric can openers are large bench or wall mount types. Handheld electric-powered can openers are known but are typically bulky which make them equally hard to use for people with disabilities or weak hands.

A particular problem with electric-powered can openers is that should the user not stop the opener after it has completely cut the can top it may cause jagged edges or swarf through further cutting action on the already cut can.

### SUMMARY OF THE INVENTION

It is an object of the present invention to provide a handheld electric-powered can opener which overcomes or ameliorates the above-mentioned problems. A particular object of the present invention is to provide a handheld electric-powered can opener that is compact, easy to hold and easy-to-use.

According to the present invention, there is provided a handheld electric-powered can opener comprising: a body having a hollow handle and a head, a battery and motor provided within the handle, a gearbox coupled to the motor, a rotational traction wheel positioned on or with the head, a rotational cutting wheel positioned on or with the head, a lever positioned with the body and having an operating position for forcing the cutting wheel against a can rim, and a switch for operating the motor when the lever is in the operating position.

Preferably wherein the handle is shaped to fit comfortably in a users hand and to accommodate the battery and motor in tandem.

Preferably the gearbox is a planetary gearbox coupled in tandem with the motor.

Preferably the cutter wheel is coupled to the lever for movement between a first position in which the can rim can be positioned between the cutter and traction wheels and a second position in which the can rim is clamped between the cutter and traction wheels.

Preferably the battery is rechargeable.

Preferably the can opener includes a stand having a holder for supporting the can opener body and a charger for supplying a charge to the battery when the body is supported by the holder.

Preferably the can opener includes a controller for stopping the motor when the can rim has been cut over its circumference.

Preferably the controller stops the motor when a torque on the motor changes.

Preferably the controller stops the motor when a current of the motor changes.

Preferably the controller comprises a control circuit and a current transducer for monitoring motor current and providing a signal to the control circuit representative of motor current.

Further aspects of the invention will become apparent from the following drawings and description.

### BRIEF DESCRIPTION OF THE DRAWINGS

Embodiments of the invention will now be described by way of example only and with reference to the accompanying drawings in which:

FIG. 1 is a handheld electric-powered can opener and stand,

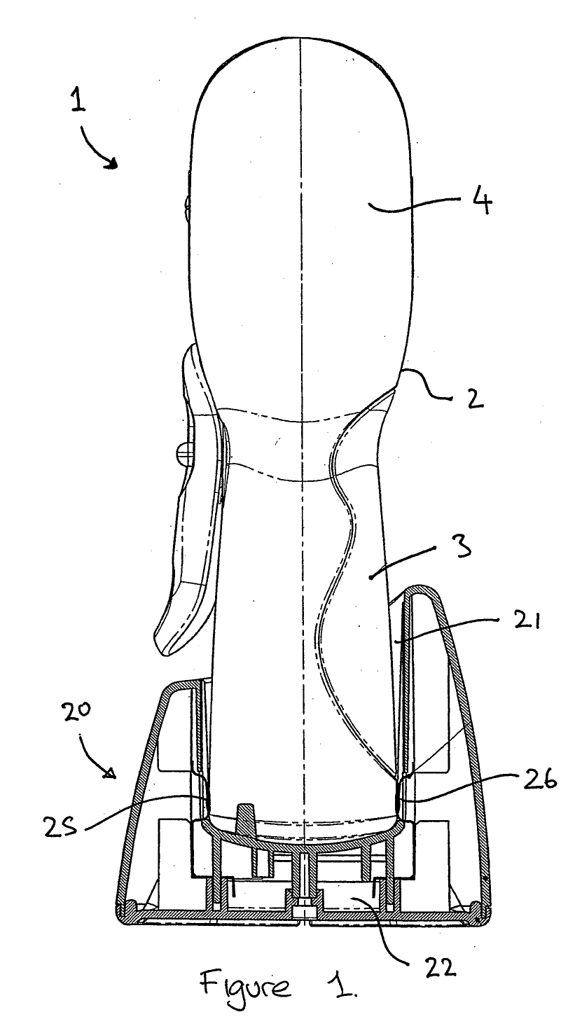

FIG. 2 is a first section view through the can opener,

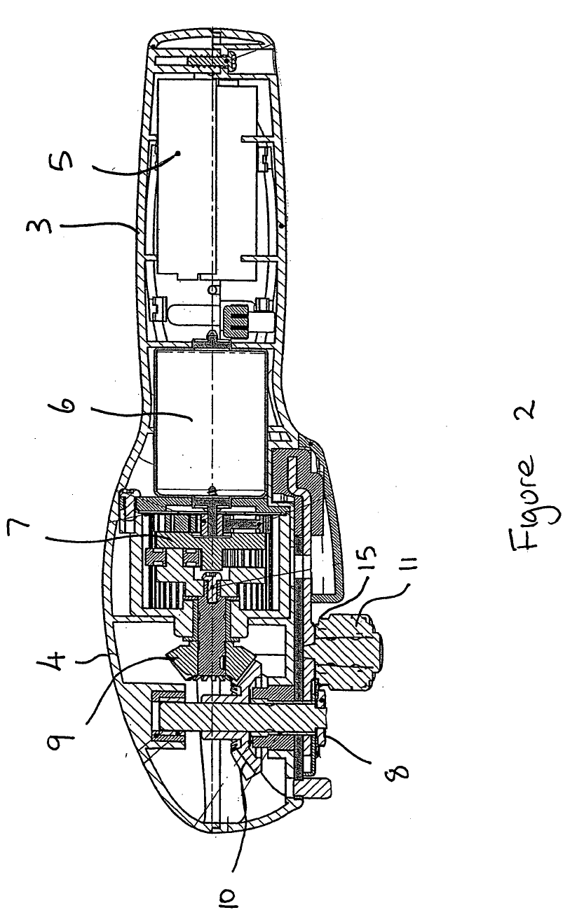

FIG. 3 is a second section view through the can opener, and

FIG. 4 is a schematic illustration of a control circuit for the can opener.

### DESCRIPTION OF THE PREFERRED EXAMPLE

Referring to the drawings, a handheld electric-powered can opener 1 includes a body 2 having a hollow handle 3 extending to a head portion 4. The handle 3 is shaped to fit comfortably in a users hand and to accommodate a rechargeable battery pack 5 and motor 6 in tandem. A planetary gearbox 7 is also coupled in tandem with the motor 6 and battery pack 5.

A traction wheel 8 is rotationaly mounted on the head 3 and coupled to the output of the planetary gearbox 7 by bevel gears 9, 10.

A cutting wheel 11 having a blade 15 is rotationaly mounted with the head 3 and coupled to a lever 12. The lever 12 is pivotally mounted to the body 2 and moves the cutter wheel 11 between a first, open, position and a second, operating, position. In the open position a can rim (not shown) can be positioned between the cutter and traction wheels 11, 8. In the operating position the can rim is clamped between the cutter and traction wheels 11, 8 and the cutter wheel 11 is forced against the outer circumference of the can rim cutting through an outer layer of the can material.

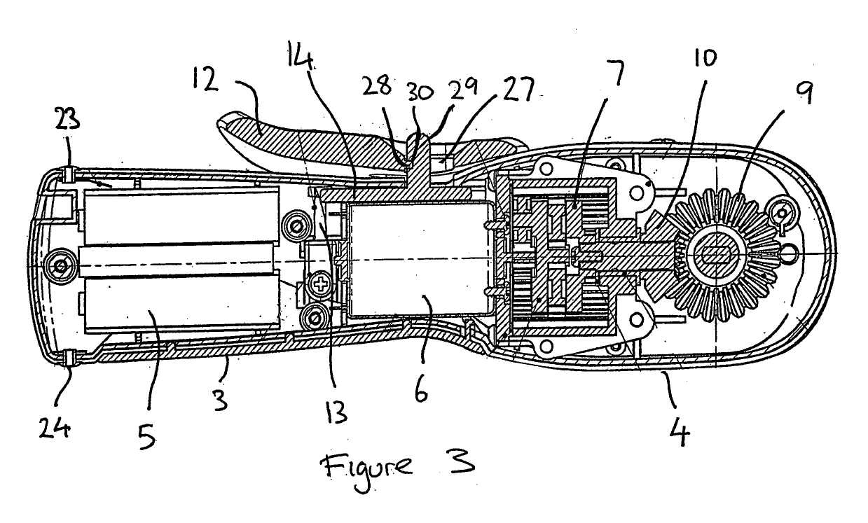

Lever 12 has a hole 27 in it. One edge of the hole 27 has a lip 28. A switch 13 and a sliding arm 14 are positioned within the body 2. Arm 14 has a knob 29 projecting orthogonally from body 2. One side of the knob 29 has a grove 30 in it. When the lever 12 is in the operating position, shown in FIG. 3, the knob 29 projects through hole 27 in lever 12. A user can slidably move knob 29 causing arm 14 to operate switch 13. Grove 30 of the knob 29 engages lip 28 of the lever 12 holding the lever 12 in the operating position. The switch 13 starts the motor 6 causing the traction wheel 8 to turn moving the can rim between the traction wheel 8 and cutter wheel 11. The blade 15 cuts through the outer layer of can material around the circumference of the can rim.

When the can opener has made one full revolution about the can rim the outer layer of can material will have been cut over its entire circumference. If the motor continues to operate the blade 15 will passed through the gap in the already cut outer layer of can material. As the blade 15 is not doing any significant work motor torque is significantly reduced. Monitoring motor torque, by either mechanical or electrical means, allows a controller to determine when the outer layer of can material around the entire can rim circumference has been cut and stop the motor even though the lever is still in the operating position.

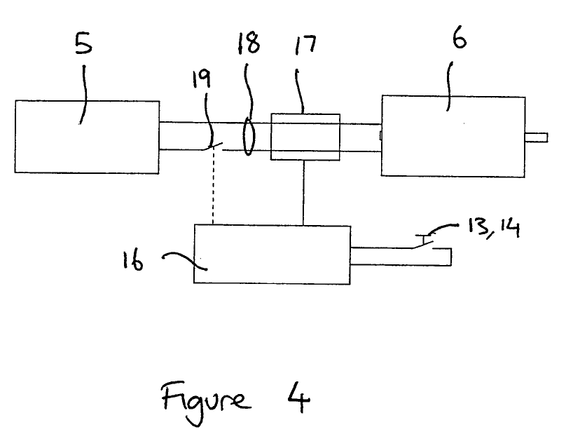

Referring to FIG. 4, in the preferred embodiment the can opener includes a controller comprising a control circuit 16 and a current sensing device such as a Hall Effect current transducer 17. The Hall Effect current transducer 17 monitors a motor current in the electrical connection 18 between battery pack 5 and motor 6 and provides control circuit 16 with signals proportional to the motor current. Start switch 13 is a part of 16. When the start switch 13 is operated control circuit 16 closes a relay contact 19 to start the motor 3. The motor start currents can be multiples higher than normal run current. After a short delay, to allow the high motor start currents to pass, the control circuit 16 monitors the motor run current. A drop in motor run current indicates a reduction and motor torque corresponding to cutting of the entire outer layer of can material around the can rim circumference. On receiving signals from the Hall Effect current transducer 17 indicating a drop in the motor run current the control circuit 16 opens relay contact 19 stopping the motor.

A stand 20 includes a holder receptacle 21 for receiving the can opener handle 3 to support the can opener when not in use. The stand 20 also includes a battery charger circuit 22 for supplying a charge to the battery 5 when the can opener is positioned on the stand 20. At the distal end of handle 3 are diametrically opposed electrical contacts 23, 24. The electrical contacts 23, 24 communicate with corresponding electrical contacts 25, 26 located within receptacle 21.

An embodiment of the invention has been described, however it is understood that variations, improvements or modifications can take place without departure from the spirit of the invention or scope of the appended claims. For example, the can opener and its stand may include induction coupling, as commonly found in electric toothbrushes, for the battery charger. And, the rechargeable battery pack may accommodate replacement of rechargeable battery cells with commonly available non-rechargeable batteries.

In a further variation of the present embodiment lever 12 may be arranged to operate switch 13 when it is moved to the operating position. The motor 6 automatically starts when the can rim is clamped between the traction and cutter wheels 8, 11. Lever 12 may be arranged to operate switch 13 by way of a button projecting through handle 3 beneath the lever 12 or a sliding linkage connected to the lever 12 near its pivot point.

Where in the foregoing description reference has been made to integers or elements having known equivalents then such are included as if individually set forth herein.

1. A handheld electric-powered can opener comprising:
a body having a hollow handle and a head,
a battery and motor provided within the handle,
a gearbox coupled to the motor,
a rotational traction wheel positioned on or with the head,
a rotational cutting wheel positioned on or with the head,
a lever positioned with the body and having an operating position for forcing the cutting wheel against a can rim, and
a switch for operating the motor when the lever is in the operating position.

2. The can opener of claim 1 wherein the handle is shaped to fit comfortably in a users hand and to accommodate the battery and motor in tandem.

3. The can opener of claim 1 wherein the gearbox is a planetary gearbox coupled in tandem with the motor.

4. The can opener of claim 1 wherein the cutter wheel is coupled to the lever for movement between a first position in which the can rim can be positioned between the cutter and traction wheels and a second position in which the can rim is clamped between the cutter and traction wheels.

5. The can opener of claim 1 wherein the battery is rechargeable.

6. The can opener of claim 5 including a stand having a holder for supporting the can opener body and a charger for supplying a charge to the battery when the body is supported by the holder.

7. The can opener of claim 1 including a controller for stopping the motor when the can rim has been cut over its circumference.

8. The can opener of claim 7 wherein the controller stops the motor when a torque on the motor changes.

9. The can opener of claim 7 wherein the controller stops the motor when a current of the motor changes.

10. The can opener of claim 7 wherein the controller comprises a control circuit and a current transducer for monitoring motor current and providing a signal to the control circuit representative of motor current.

11. A handheld electric-powered can opener comprising:
a body having a handle and a head,
a battery, a motor and a planetary gearbox provided in tandem within the body, the battery and motor being within the handle,
a rotational traction wheel positioned on or with the head,
a rotational cutting wheel positioned on or with the head,
a lever positioned with the body and having an operating position for forcing the cutting wheel against a can rim,
a switch for operating the motor when the lever is in the operating position, and
a controller for stopping the motor when the can rim has been cut over its circumference.

12. The can opener of claim 11 wherein the controller stops the motor when a torque on the motor changes.

13. The can opener of claim 11 wherein the controller stops the motor when a current of the motor changes.

14. The can opener of claim 11 wherein the controller comprises a control circuit and a current transducer for monitoring motor current and providing a signal to the control circuit representative of motor current.
